(19) United States
(12) Patent Application Publication
(10) Pub. No.: US 2009/0036283 A1
(43) Pub. Date: Feb. 5, 2009

(54) ROLLER OF THERMOSTRUCTURAL COMPOSITE MATERIAL

(75) Inventor: Jean-Pierre MAUMUS, Saint Medard en Jalles (FR)

Correspondence Address: WEINGARTEN, SCHURGIN, GAGNEBIN & LEBOVICI LLP, TEN POST OFFICE SQUARE, BOSTON, MA, 02109, US

(73) Assignee: SNECMA PROPULSION SOLIDE, Le Haillan (FR)

(21) Appl. No.: 12/181,497

(22) Filed: Jul. 29, 2008

(30) Foreign Application Priority Data
Jul. 30, 2007 (FR) 0756793

(51) Int. Cl. B21B 27/02; F16C 13/00

(52) U.S. Cl. 492/53; 492/3; 72/199

(57) ABSTRACT

The invention relates to a roller comprising an axial support element made of metal and comprising at least two shafts, and a cylindrical shell made of thermostructural composite material. In order to compensate for differential expansion between the metal axial support element and the cylindrical shell made of thermostructural composite material, radial clearance is provided with the axial support element and the cylindrical shell.

### BACKGROUND OF THE INVENTION

The present invention relates to the field of rollers used for transporting, guiding, or shaping industrial products such as paper, steel, or aluminum. The invention relates more particularly to rollers that are to be subjected to high temperatures and to steep temperature gradients.

It is common practice in the steel-working or metal-working industry to use rollers for forming flat products such as steel or aluminum sheet. The rollers used in that type of industry are generally made of refractory steel since they can be subjected to very high thermomechanical loading, as occurs for example in chambers for performing continuous heat treatment on metal sheet (annealing) in which the mechanical forces exceed several tons and the temperature can reach 850° C. to 1000° C. Furthermore, there exist steep temperature gradients between the rollers and the metal sheet. At the entry to the chamber, the first rollers are at the temperature to which the chamber is heated (850° C.-1000° C.), whereas the metal sheet traveling over them is at ambient temperature, thereby causing to the cylindrical profile of the rollers to become deformed towards a somewhat diabolo-shaped profile. Conversely, the rollers at the exit from the chamber are at ambient temperature while the sheet metal traveling over them is still at the temperature to which the chamber is heated, which leads to the cylindrical profile of the rollers becoming deformed towards a centrally-bulging profile.

Consequently, the temperature levels and the temperature gradients that are encountered need to be taken into account when designing rollers in order to avoid forming heat buckles in the sheet metal, and in order to avoid poor guidance thereof (deflection) as a result of a roller deforming under the effect of temperature. Sheet metal passing over a roller that is not cylindrical leads to differential mechanical stresses that, where superposed on other mechanical stresses (traction on the sheet, weight, etc.), can exceed the elastic limit of the sheet metal and cause buckles to form.

Solutions have been devised to mitigate this problem. Among these solutions, one consists in using sheet metal of a specific width, but that prevents the same installation being used to treat sheet metal of some other width.

Another solution consists in using metal rollers comprising two layers, in which one of the two layers (generally made of copper) has the sole function of improving the mean thermal conductivity of the roller so as to reduce the deformation of its cylindrical profile. That solution is expensive and does not guarantee that the profile of the roller will not deform under all temperature conditions.

In yet another solution, the rollers present a profile when cold that is intended to ensure that the roller has a profile that is substantially rectilinear once it is at high temperature.

### OBJECT AND SUMMARY OF THE INVENTION

An object of the present invention is to propose a novel roller structure presenting an outside shape that does not vary under the effect of high temperatures and/or during rapid changes of temperature, the roller also being of a design that enables it to replace existing rollers without needing to modify installations.

To this end, the present invention provides a roller comprising an axial support element made of metal and comprising at least two shafts, and a cylindrical shell made of thermostructural composite material, wherein radial clearance is provided between the axial support element and the cylindrical shell, or wherein the contacting surfaces between the axial support element and the cylindrical shell present a center of symmetry coinciding with the axis of said shell.

Thus, the outer shape of the roller of the invention is defined by a cylindrical shell of thermostructural composite material, which material presents a coefficient of thermal expansion that is small, thus making it possible to avoid the shell deforming under the effect of high temperatures. In addition, the thermostructural material presents high thermal conductivity, thus enabling the shell to be brought rapidly and uniformly up to temperature and enabling temperature gradients in the outer surface of the roller to be reduced. This good thermal conductivity thus serves to prevent deformations appearing in the sheet metal when it is at a temperature that is different from the temperature of the roller.

Thermostructural composite material also presents sufficient mechanical strength to withstand the same loads as prior art rollers.

Furthermore, in order to enable the roller of the present invention to be fitted to existing installations (e.g. in installations for continuously annealing sheet metal), the roller of the invention conserves an axial support element that is made of metal and that comprises at least two shafts for supporting and/or driving the roller. Thus, those portions of installations that co-operate with the rollers (bearings, drive shafts, etc.) do not need to be modified in order to receive the rollers of the invention, thereby enabling existing rollers merely to be replaced by rollers of the invention.

Nevertheless, since the axial support element is made of metal, it possesses a coefficient of thermal expansion that is greater than that of the cylindrical shell, which leads to differential expansion between said element and the shell. In order to avoid the cylindrical shell deforming under the effect of expansion of the axial support element, the roller of the invention either presents radial clearance provided between the axial support element and the cylindrical shell, or it presents contacting surfaces between the axial support element and the cylindrical shell with a center of symmetry that coincides with the axis of said shell.

Thus, expansions of the axial support element do not lead to deformation of the shell, such expansions being compensated either in the radial clearance that is present between the support and the shell, or by relative sliding between these two elements having a center of symmetry for the portions that are in contact that coincides with the axis of the shell.

In an aspect of the invention, the cylindrical shell is made of carbon/carbon co-composite material, which material presents both a low coefficient of thermal expansion and good thermal conductivity. Other thermostructural or composite materials presenting a ratio of thermal expansion coefficient divided by thermal conductivity that is close to zero can also be used for making the cylindrical shell, such as the material Invar, for example.

The cylindrical shell may also include on its outer surface a layer of chromium carbide, which layer serves to avoid carburizing products that come into contact with the roller (e.g. sheet metal). Under such circumstances, a layer of silicon carbide may be formed prior to forming the layer of chromium carbide in order to decouple the layer of chromium carbide thermally from the thermostructural composite material of the shell, so as to facilitate bonding between these two materials.

In an embodiment of the invention, the axial support element comprises a mandrel extended at each end by a shaft, the cylindrical shell being disposed around the mandrel, with radial clearance being provided between the inner surface of the shell and the outer surface of the mandrel. In this way, radial expansions of the mandrel are compensated by the radial clearance provided between the mandrel and the cylindrical shell.

In an aspect of this embodiment, the cylindrical shell includes at least one series of teeth disposed in annular manner on its inner surface, while the mandrel includes a plurality of splines. This design enables the shell to be coupled to rotate with the mandrel while conserving radial clearance between these two items. Adjustment spacers may be placed between the adjacent edges of the teeth and of the splines so as to keep the cylindrical shell in position around the mandrel.

In another embodiment of a roller of the invention, the cylindrical shell of thermostructural composite material is self-supporting and the axial support element comprises two shafts, each shaft being connected to one end of the shell of thermostructural composite material by an element of frustoconical shape. In this embodiment, the cylindrical shell does not come directly into contact with the two shafts constituting the axial support element that is made of metal. The two shafts are coupled to the shell via respective elements of frustoconical shape defining contact surfaces with the shafts that present generator points (centers of symmetry) that lie on the axis of symmetry of the shell. The differential expansion between the shafts and the shell is then compensated in the elements of frustoconical shape.

The elements of frustoconical shape are fastened firstly to the ends of the cylindrical shell via their large-diameter ends, and secondly to the shafts via their small-diameter ends.

In yet another embodiment of a roller of the invention, the cylindrical shell of thermostructural composite material is self-supporting and the axial support element comprises a mandrel extended at each end by a shaft. The cylindrical shell is connected to said mandrel via two conical engagement rings fastened to respective ends of the mandrel. The generator lines of the contacting portions between the rings and the cylindrical shell coincide at a point situated on the axis of the shell, thus serving to compensate differential expansion between the shell and the other parts of the roller.

### BRIEF DESCRIPTION OF THE DRAWINGS

Other characteristics and advantages of the invention appear from the following description of particular embodiments of the invention given as non-limiting examples, with reference to the accompanying drawings, in which:

FIG. 1 is a diagrammatic view of a thermostructural composite roller constituting an embodiment of the invention;

FIG. 2 is a section view on plane II-II of FIG. 1;

FIG. 3 is a diagrammatic view of a thermostructural composite roller constituting another embodiment of the invention;

FIG. 4 is an exploded view of a portion of the FIG. 3 roller showing how a shaft is assembled to one end of the roller;

FIG. 5 is a diagrammatic view of a thermostructural composite roller constituting yet another embodiment of the invention;

FIG. 6 shows an example of how differential expansion is compensated with the roller of FIG. 5; and

FIG. 7 is a section view of the FIG. 3 roller.

### DETAILED DESCRIPTION OF AN EMBODIMENT

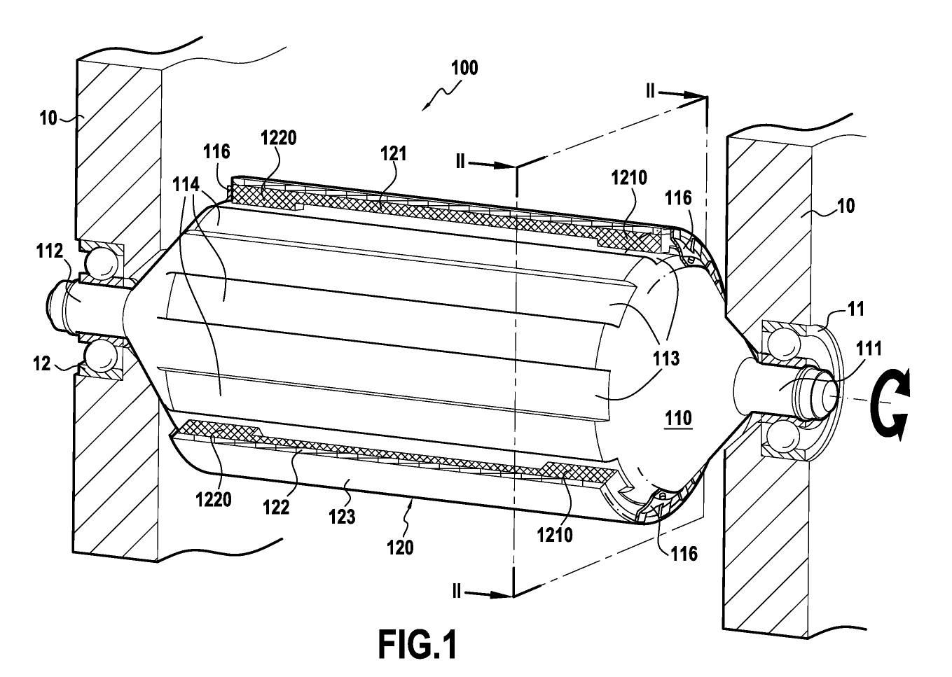

A particular but non-exclusive field of application for the invention is that of continuous annealing installations or lines in which sheet metal strips are processed. FIG. 1 shows a roller 100 constituting an embodiment of the invention that can be used equally well for the purposes of transporting, guiding, or shaping a sheet metal strip in an annealing line.

As its axial support element, the roller 100 comprises a mandrel 110 having each of its ends extended by a respective shaft 111 or 112. In this example, the roller 100 is placed inside an enclosure 10 of an annealing oven. The shafts 111 and 112 are supported by respective bearings 11 and 12 of the enclosure 10. The or each shaft 111, 112 may also be coupled with rotary drive means (not shown).

The roller 100 also comprises a cylindrical shell 120 for forming the outer wall of the roller. The cylindrical shell 120 is constituted by an axially-symmetrical part 121 of thermostructural composite material, i.e. of composite material that has good mechanical properties and the ability to conserve these properties are high temperature. The axially symmetrical part 121 is preferably made of a carbon/carbon (C/C) composite material, which, in known manner, is a material made of carbon fiber reinforcement densified by a carbon matrix. The material also presents a low coefficient of thermal expansion (about 2.5×10⁻⁶ per ° C.) compared with the coefficients of metals such as steel (about 12.10×10⁻⁶ per ° C.). Consequently, the shell 120 constituting the portion of the roller 100 that is to come into contact with the sheet for treatment expands very little under the effect of temperature.

Fabricating parts made of C/C composite material is well known. It generally comprises making a carbon fiber preform of shape close to that of the part that is to be fabricated, and then densifying the preform with the matrix.

The fiber preform constitutes the reinforcement of the part and its essential function relates to mechanical properties. The preform is obtained from fiber fabrics: yarns, tows, braids, cloths, felts, . . . . Forming is performed by winding, weaving, stacking, and possibly also needling two-dimensional plies of cloth or sheets of tows . . . .

The fiber reinforcement can be densified by a liquid technique (impregnating with a precursor resin for the carbon matrix and transforming it by cross-linking and pyrolysis, which process might be repeated) or using a gas technique (chemical vapor infiltration (CVI) of the carbon matrix).

In an aspect of the invention, the cylindrical shell may further comprise a coating constituted by a layer of chromium carbide 123 that serves in particular to avoid the metal of the sheets being carburized by the axially symmetrical part 121. Under such circumstances, a silicon carbide layer 122 is preferably formed between the part 121 and the chromium carbide layer 123 in order to isolate the C/C material of the part 121 from the metal of the layer 123. The silicon carbide layer 122 acts as a bonding layer between the C/C material of the axially symmetrical part 121 and the layer of chromium carbide 123. The layers of silicon carbide 122 and of chromium carbide 123 can be made by a variety of known deposition techniques such as, for example physical vapor deposition (PVD).

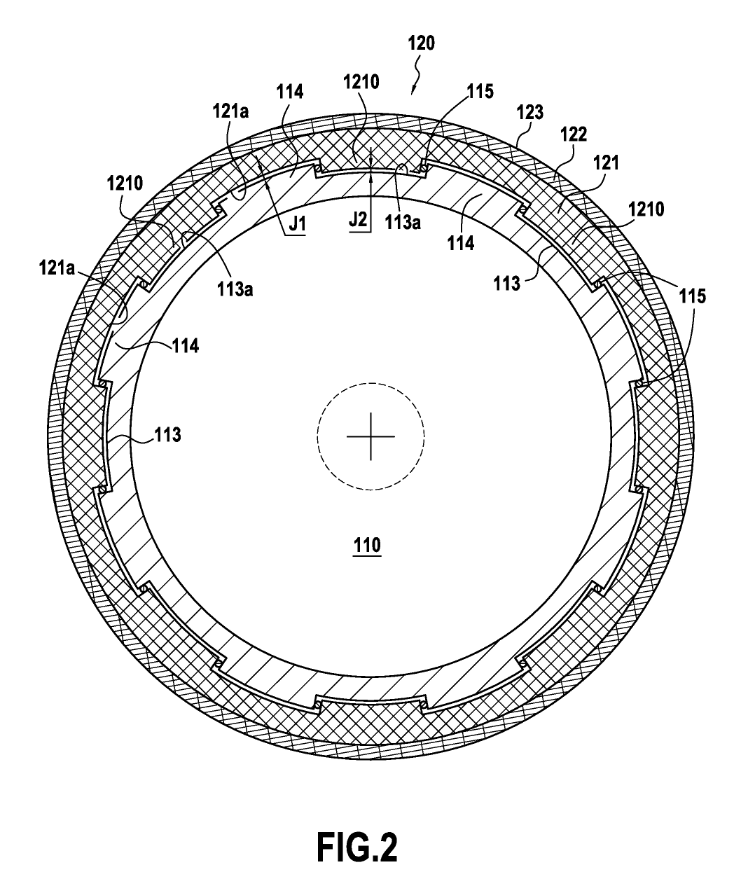

As shown in FIGS. 1 and 2, the part 121 presents two series of teeth 1210 and 1220 on its inside surface, the teeth 1210 and 1220 being distributed in annular manner on the inside surface of the part 121 and being aligned in pairs along the axis of the axially symmetrical part 121. The series of teeth 1210 and 1220 may be formed directly while fabricating the composite material part by forming the fiber reinforcement so as to have regions of greater thickness in the places that correspond to the locations of the teeth, or else they may be formed after the part has been fabricated by machining its inside surface.

The cylindrical shell is placed around a mandrel 110 by engaging the series of teeth 1210 and 1220 in grooves 113 formed in the outer surface of the mandrel 110, e.g. by machining. The grooves 113 are distributed uniformly around the mandrel, and between them they define splines 114.

As shown in FIG. 2, the cylindrical shell 120 is positioned around the mandrel 110 while leaving radial clearance between the facing surfaces of these two elements. More precisely, the mandrel 110 and the axially symmetrical part 121 of the shell 120 are dimensioned in such a manner as to leave firstly radial clearance J1 between the tops of the splines 114 and the inside surface portions 121a of the part 121 facing said splines, and secondly radial clearance J2 between the tops of the teeth 1210 and 1220 and the bottoms 113a of the grooves 113. Thus, although the part 121 made of thermostructural composite material presents a coefficient of expansion that is much less than that of the mandrel made of metal material, differential expansion between these two elements can be compensated by the presence of radial clearance between the shell 120 and the mandrel 110.

When temperature rises, the mandrel expands radially into the clearance that is provided, without exerting force on the shell, thus avoiding deforming the shell. In this example, the shell 120 is held in position on the mandrel 110 by means of adjustment spacers 115, e.g. made of metal (steel), that are disposed respectively between adjacent edges of the teeth 1210, 1220 and the splines 114. Other positioning means could also be envisaged. By way of example, the cylindrical shell could be held in position by friction between the adjacent edges of the teeth and of the splines.

Mechanical coupling between the cylindrical shell 120 and the mandrel 110 is provided by engaging the teeth 1210 and 1220 with the adjacent edges of the splines, optionally via the adjustment spacers 115 when present. The cylindrical shell 120 is also constrained in translation on the mandrel 110 by means of resilient holder elements 116 disposed at each end of the cylindrical shell 120. The elements 116 are fastened to the mandrel 110 and the spring blades constituted by these elements exert holding pressure on the shell. The resilient holder elements 116 serve to hold the cylindrical shell 120 in balanced manner in longitudinal position on the mandrel 110.

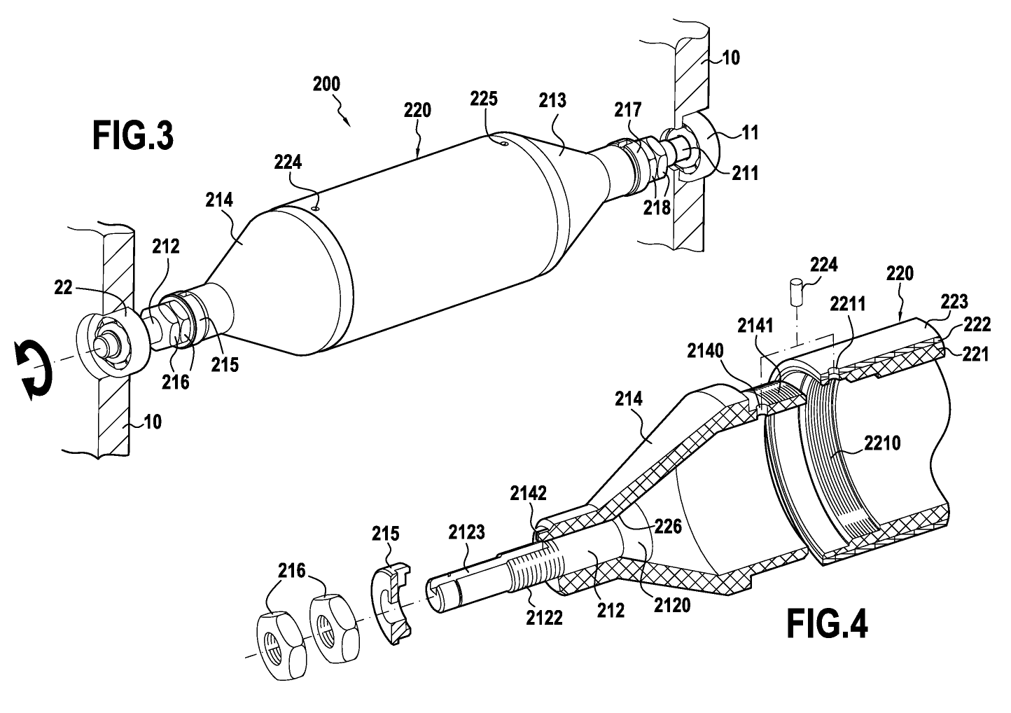

Another embodiment of a roller of the invention is described below with reference to FIGS. 3 and 4. FIGS. 3 and 4 show a roller 200 that differs from the above-described roller 100 specifically in that it has a cylindrical shell 220 that is self-supporting, i.e. that presents structure that is strong enough to withstand the forces to which the roller is subjected without any need for internal support. For this purpose, the cylindrical shell 220 is constituted by an axially symmetrical part 221 made of thermostructural composite material, preferably of C/C material, that imparts sufficient mechanical strength to the shell to make it self-supporting. Like the above-described cylindrical shell, the axially symmetrical part 221 may be covered in a layer of chromium carbide 223 with an interposed layer of silicon carbide 222. The technique used for making the axially symmetrical part 221 out of thermostructural composite material, and also for depositing the layers of silicon carbide 222 and of chromium carbide 223 are similar to those described above for the cylindrical shell 120.

The roller 200 has two shafts 211 and 212 that are supported by respective bearings 21 and 22 of an enclosure 20 of an annealing furnace. The shafts 211 and 212 are connected to the cylindrical shell 220 via respective frustoconical elements 213 and 214. More precisely, and as shown in FIG. 4, the shaft 212 is placed inside the frustoconical element 214 via its small-diameter end. The shaft 212 presents a flared portion 2120 at one end that acts as an abutment, while at its other end it has a threaded portion 2122 and a groove 2123 going beyond the end of the frustoconical element 214. At its large-diameter end, the frustoconical element 214 has a thread 2141 for co-operating with a thread 2210 made on the inside wall of the axially symmetrical part 221. The frustoconical element 214 is screwed to the part 221 of the shell 220 and then secured thereto by means of a pin 224 fastened in orifices 2211 and 2140 formed respectively in the shell 220 and in the frustoconical element 214. The shaft 212 is constrained to rotate with the frustoconical element 214 by a washer 215 that is shaped to engage both with the groove 2123 of the shaft 212 and with a stud 2142 of the frustoconical element 214. The washer is clamped onto the shaft 212 by means of two nuts 216 that co-operate with the thread 2122 on the shaft.

Similarly, the shaft 211 is assembled to the other end of the shell 220 by means of the frustoconical element 213 that is screwed to the shell 220 and secured thereto by a pin 225. Still in the same manner as described for the shaft 212, the shaft 211 is constrained to rotate with the frustoconical element 213 by a washer 217 and two nuts 218.

The person skilled in the art will have no difficulty in devising other variant embodiments for fastening and securing shafts to the frustoconical elements.

The shafts 211 and 212 are made of metal such as steel and the frustoconical elements 213 and 214 are made of thermostructural composite material, and preferably of a material that is identical to that of the part 221, specifically C/C in this embodiment.

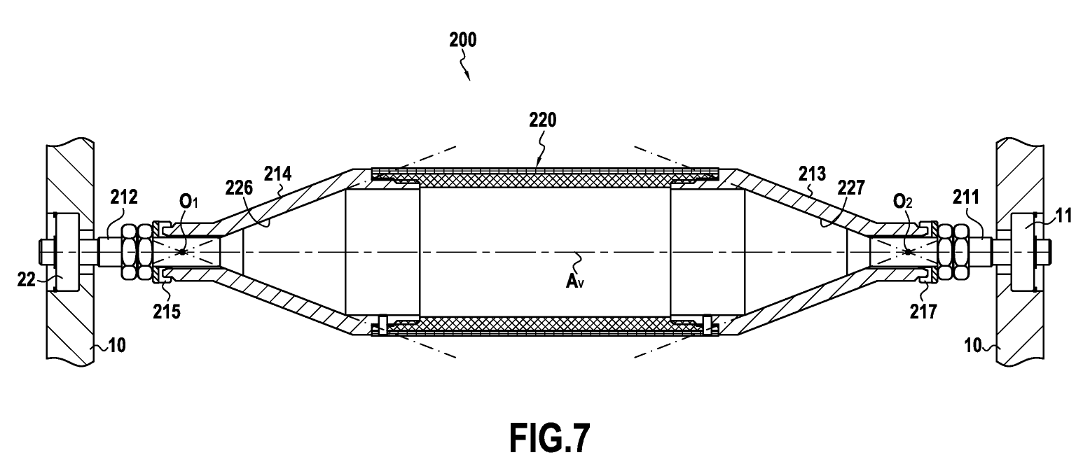

During temperature rises, the shafts 211 and 212 expand, while the cylindrical shell 220 conserves its volume because of its small coefficient of expansion. Nevertheless, because of the frustoconical elements, the expansions of the shafts do not lead to deformation of the cylindrical shell. As shown in FIG. 7, the contacting surfaces 226, 227 between the shafts and the frustoconical elements have respective centers of symmetry (or generator point) O₁, O₂ that lie on the axis Av of the cylindrical shell, and consequently of the roller. Since the shafts 211 and 212 expand both radially and axially, their increase in volume takes place towards the inside of the frustoconical elements 213 and 214 that present increasing inside volume because of their frustoconical shape. Thus, expansion of the shaft does not lead to deformation of the cylindrical shell.

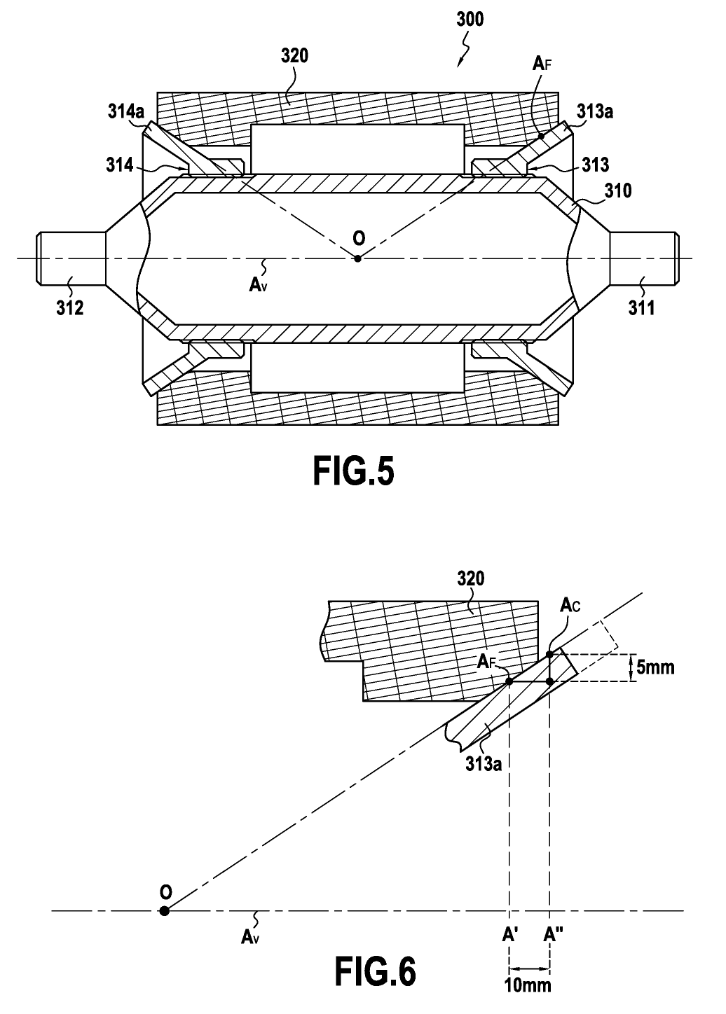

FIG. 5 shows a variant embodiment of a roller of the invention that comprises, like the above-described roller 200, a self-supporting cylindrical shell. More precisely, FIG. 5 shows a roller 300 comprising a steel mandrel 310 with each of its ends extended by a respective shaft 311, 312. The roller 300 also has a self-supporting cylindrical shell 320 made of thermostructural composite material, preferably of C/C material optionally covered in a layer of chromium carbide with an interposed layer of silicon carbide (not shown in FIG. 5). The cylindrical shell 320 is connected to the mandrel 310 via two conical engagement rings 313 and 314 that are screwed to respective ends of the mandrel. The cylindrical shell 320 is held in position around the mandrel 310 by making contact with the conical portions 313a and 314a of the rings 313 and 314 respectively. Like the roller 200 described above, differential expansion between the steel portions of the roller and the cylindrical shell of thermostructural composite material (in this example made of C/C material), are compensated by the fact that the portions in contact with the cylindrical shell are constituted by the conical portions 313a and 314a presenting generator points or centers of symmetry of that coincide with the axis of the cylindrical shell Av.

An example of this compensation technique is shown in FIG. 6 which shows the relative movements of the parts of the roller 300 in the event of temperature rising to 1000° C. The tangent OA_{F} corresponds to the generator line of the conical portion 313a of the conical engagement ring 313 for its surface making contact with the cylindrical shell. The point O corresponds to the point where the generator lines of the conical portions of the rings 313 and 314 intersect the axis of the cylindrical shell 320. The mandrel is made of steel having a thermal coefficient of expansion of 10×10⁻⁶ per ° C., while the cylindrical shell is made of C/C material that presents a coefficient of expansion of about 2.5×10⁻⁶ per ° C. The tangent OA_{F} corresponds to the hypotenuse of a right-angle triangle whose other two sides are the distances OA′ and A_{F}A′. At the temperature of 1000° C., the portion 313a expands (radially and axially), corresponding to lengthening the distance OA_{F} by moving the point A_{F} to the point A_{C}. At this temperature, the distance OA′ increases by 10 millimeters (mm) (axial distance A′A″) while the distance A_{F}A′ increased by 5 mm (radial distance A_{C}A″). It can be seen that the movement of the point A_{F} to the point A_{C} takes place in line with the tangent OA_{F}, i.e. following the generator line that intersects the point O situated on the axis of the roller.

1. A roller comprising an axial support element made of metal and comprising at least two shafts, and a cylindrical shell made of thermostructural composite material, wherein radial clearance is provided between the axial support element and the cylindrical shell.

2. A roller according to claim 1, wherein the cylindrical shell is made of carbon/carbon co-composite material.

3. A roller according to claim 2, wherein the cylindrical shell includes on its outer surface a layer of chromium carbide.

4. A roller according to claim 3, wherein the cylindrical shell further includes a layer of silicon carbide formed under the layer of chromium carbide.

5. A roller according to claim 1, wherein the axial support element comprises a mandrel extended at each end by a shaft, and wherein said cylindrical shell is disposed around the mandrel, radial clearance being provided between the inner surface of the shell and the outer surface of the mandrel.

6. A roller according to claim 5, wherein the cylindrical shell includes at least one series of teeth disposed in annular manner on its inner surface, and wherein the mandrel includes a plurality of splines, said teeth being engaged with said splines.

7. A roller according to claim 6, further including adjustment spacers disposed between the adjacent edges of the teeth and the splines in such a manner as to hold the cylindrical shell in position around the mandrel.

8. A roller comprising an axial support element made of metal and comprising at least two shafts, and a cylindrical shell made of thermostructural composite material, wherein the contacting surfaces between the axial support element and the cylindrical shell present a center of symmetry coinciding with the axis of said shell.

9. A roller according to claim 8, wherein the cylindrical shell is made of carbon/carbon co-composite material.

10. A roller according to claim 9, wherein the cylindrical shell includes on its outer surface a layer of chromium carbide.

11. A roller according to claim 10, wherein the cylindrical shell further includes a layer of silicon carbide formed under the layer of chromium carbide.

12. A roller according to claim 8, wherein the cylindrical shell of thermostructural composite material is self-supporting and wherein the axial support element comprises two shafts, each shaft being connected to one end of the shell of thermostructural composite material by an element of frustoconical shape.

13. A roller according to claim 12, wherein the elements of frustoconical shape are fastened to the ends of the cylindrical shell via their large-diameter ends and wherein said elements of frustoconical shape are fastened to the shafts via their small-diameter ends.

14. A roller according to claim 8, wherein the cylindrical shell of thermostructural composite material is self-supporting and wherein the axial support element comprises a mandrel extended at each end by a shaft, the cylindrical shell being connected to said mandrel via two conical engagement rings fastened to respective ends of the mandrel.

15. A roller according to claim 4, wherein
the axial support element comprises a mandrel extended at each end by a shaft, and wherein said cylindrical shell is disposed around the mandrel, radial clearance being provided between the inner surface of the shell and the outer surface of the mandrel;
the cylindrical shell includes at least one series of teeth disposed in annular manner on its inner surface, and wherein the mandrel includes a plurality of splines, said teeth being engaged with said splines;
adjustment spacers are disposed between the adjacent edges of the teeth and the splines in such a manner as to hold the cylindrical shell in position around the mandrel.

16. A roller according to claim 11, wherein
the cylindrical shell of thermostructural composite material is self-supporting and wherein the axial support element comprises two shafts, each shaft being connected to one end of the shell of thermostructural composite material by an element of frustoconical shape;
the elements of frustoconical shape are fastened to the ends of the cylindrical shell via their large-diameter ends and wherein said elements of frustoconical shape are fastened to the shafts via their small-diameter ends.

17. A roller according to claim 11, wherein the cylindrical shell of thermostructural composite material is self-supporting and wherein the axial support element comprises a mandrel extended at each end by a shaft, the cylindrical shell being connected to said mandrel via two conical engagement rings fastened to respective ends of the mandrel.
